(19) United States
(12) Patent Application Publication
(10) Pub. No.: US 2005/0214516 A1
(43) Pub. Date: Sep. 29, 2005

(54) Multi-layer ceramic substrate and manufacturing method thereof

(75) Inventors: Hideki Yoshikawa, Takarazuka-shi (JP); Hiroshi Nonoue, Osaka (JP); Kenichiro Wakisaka, Iga-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/075,759

(22) Filed: Mar. 10, 2005

(30) Foreign Application Priority Data
Mar. 23, 2004 (JP) 2004-084915

(51) Int. Cl. B32B 3/00

(52) U.S. Cl. 428/209; 156/89.12; 428/210

(57) ABSTRACT

A multi-layer ceramic substrate is formed of a plurality of glass-ceramic layers. The glass-ceramic layers (partly not shown) contain amorphous glass and alumina (Al₂O₃), and interconnection patterns of silver are formed in the surfaces of the glass-ceramic layers. The amorphous glass is anorthite (CaAl₂Si₂O₈), for example. With the multi-layer ceramic substrate, the upper limit of the firing temperature is set so that the degree of crystallinity is 12% or less. The lower limit of the firing temperature is set so that the multi-layer ceramic substrate has a sintered density of 95% or more with respect to the sintered density that the multi-layer ceramic substrate exhibits when the degree of crystallinity is 25%.

The priority application Number 2004-084915 upon which this patent application is based is hereby incorporated by reference.

### BACKGROUND OF THE INVENTION

1. Field of the Invention

The present invention relates to a multi-layer ceramic substrate formed of stacked glass-ceramic layers and a method of manufacturing the multi-layer ceramic substrate.

2. Description of the Background Art

Because of the great demand for size reduction of mobile communication devices and portable communication terminals, such as mobile phones, it is necessary to achieve size reduction and higher performance of high-frequency circuit substrates used as their functional unit.

Accordingly, in the manufacture of high-frequency circuit substrates, the technique of mounting surface-mount components, such as capacitors or inductors, on printed wiring boards is being replaced by the multi-layer ceramic substrate technique, in which capacitance or inductance components are made by forming interconnection patterns on green sheets that form the ceramic substrates (for example, see Japanese Patent Application Laid-Open No. 2000-185978).

For example, a multi-layer ceramic substrate is manufactured by forming interconnection patterns on a plurality of green sheets mainly made of alumina (Al₂O₃), stacking the plurality of green sheets on top of each other, and co-firing the green sheets at a temperature of about 900° C. to integrate them.

FIGS. 14A and 14B are schematic perspective views illustrating a conventional method for manufacturing a multi-layer ceramic substrate.

As shown in FIG. 14A, first, given interconnection patterns 32A to 32D are formed by screen-printing respectively on green sheets 31A to 31D made of alumina. Next, as shown in FIG. 14B, the green sheets 31A to 31D are stacked on top of each other and co-fired at a temperature of about 900° C., whereby a multi-layer ceramic substrate 30 is formed. The green sheets are formed by mixing and kneading organic binder, ceramic material powder, etc., processing it into sheet form, and then drying it.

In the multi-layer ceramic substrate 30, capacitance or inductance can be obtained within the multi-layer ceramic substrate by forming the given interconnection patterns 32A to 32D by screen-printing on the green sheets 31A to 31D of alumina. This reduces the number of capacitors or inductors as surface-mount components, and allows size reduction of the high-frequency circuit parts.

The formation of the interconnection patterns 32A to 32D generally uses silver having high electric conductivity and capable of being fired in the atmosphere. However, as compared with other conductor materials, silver is more likely to diffuse and so tends to cause migration.

FIG. 15 is a diagram schematically illustrating the migration.

As shown in FIG. 15, in the multi-layer ceramic substrate, the interconnection pattern 32C of silver is formed between the glass-ceramic layers 31C and 31D and the interconnection pattern 32D of silver is formed between the glass-ceramic layers 31D and 31E.

In this case, a short circuit 35 is formed by the migration of silver between the interconnection patterns 32C and 32D formed on the opposite sides of the glass-ceramic layer 31D, which causes poor insulation between the glass-ceramic layers and thus reduces reliability and yield of the multi-layer ceramic substrate.

Preventing the migration phenomena is thus extremely important in the manufacture of multi-layer ceramic substrates. However, in spite of various studies and suggestions made to prevent metal migration (Japanese Patent Application Laid-Open No. 2003-46033), the mechanism of occurrence of the migration still remains unclear and effective prevention of the migration has not yet been achieved.

### SUMMARY OF THE INVENTION

An object of the present invention is to provide a multi-layer ceramic substrate with enhanced reliability and with improved yield and hence reduced manufacturing costs, and a method of manufacturing the multi-layer ceramic substrate.

Conventionally, it has been common technical practice to set high firing temperatures of 880° C. or more during the manufacture of multi-layer ceramic substrates. However, the inventors of the present invention have carried out various experiments and investigations to find that the migration can be suppressed by setting lower firing temperatures so that the multi-layer ceramic substrates exhibit lower degrees of crystallinity, and thus made the present invention.

According to an aspect of the present invention, a multi-layer ceramic substrate includes a plurality of stacked glass-ceramic layers and an interconnection pattern made of a metal material and formed in at least one surface of the plurality of glass-ceramic layers. The plurality of glass-ceramic layers contain amorphous glass and alumina, and the degree of crystallinity, which is represented as a ratio of an x-ray diffraction peak intensity of the amorphous glass to an x-ray diffraction peak intensity of the alumina, is 12% or less.

In the multi-layer ceramic substrate, an interconnection pattern of a metal material is formed in at least one surface of the plurality of glass-ceramic layers and the glass-ceramic layers are stacked on top of each other.

In this case, it is thought that the metal material, even when ionized, cannot move within the glass-ceramic layers because the degree of crystallinity, which is represented as a ratio of an x-ray diffraction peak intensity of the amorphous glass to an x-ray diffraction peak intensity of the alumina, is 12% or less. This prevents electrical short circuits that would be caused by migration. This, in turn, enhances the yield of the multi-layer ceramic substrate and hence reduces the manufacturing costs, and also improves the reliability of the multi-layer ceramic substrate.

Preferably, the plurality of glass-ceramic layers have a density of 95% or more with respect to a density that the glass-ceramic layers exhibit when the degree of crystallinity is 25%. In this case, the glass-ceramic layers offer sufficient strength and sufficient density.

Preferably, the amorphous glass includes silicic acid. This makes it easy to obtain a degree of crystallinity of 12% or less.

Preferably, the amorphous glass includes anorthite. This makes it still easier to obtain a degree of crystallinity of 12% or less.

The metal material may include silver. Though silver is susceptible to migration, setting the degree of crystallinity at 12% or less satisfactorily suppresses electric short circuits even when the interconnection pattern is formed of silver.

The interconnection pattern has portions that oppose each other and a region of the glass-ceramic layers that is interposed between the opposite portions preferably has a silver content of 4% or less. This sufficiently prevents electric short circuits.

In the plurality of glass ceramic layers, the amorphous glass content “a” may be not less than 33 percent by weight nor more than 59 percent by weight and the alumina content “b” may be not less than 35 percent by weight nor more than 55 percent by weight, with a+b being not more than 100 percent by weight.

This makes it still easier to obtain a degree of crystallinity of 12% or less.

According to another aspect of the invention, a method for manufacturing a multi-layer ceramic substrate includes the steps of forming a plurality of glass-ceramic layers that contain amorphous glass and alumina, providing an interconnection pattern of a metal material in at least one surface of the plurality of glass-ceramic layers, and stacking the plurality of glass-ceramic layers and firing the plurality of glass-ceramic layers at such a firing temperature that a degree of crystallinity, which is represented as a ratio of an x-ray diffraction peak intensity of the amorphous glass to an x-ray diffraction peak intensity of the alumina, is 12% or less.

In the multi-layer ceramic substrate manufacturing method, a plurality of glass-ceramic layers that contain amorphous glass and alumina are formed. Next, an interconnection pattern of a metal material is formed in at least one surface of the plurality of glass-ceramic layers. Then, the plurality of glass-ceramic layers are stacked on one another and fired.

In this case, it is thought that the metal material, even when ionized, cannot move within the glass-ceramic layers because the firing temperature is set so that the degree of crystallinity, which is represented as a ratio of an x-ray diffraction peak intensity of the amorphous glass to an x-ray diffraction peak intensity of the alumina, is 12% or less. This prevents electrical short circuits that would be caused by migration. This, in turn, enhances the yield of the multi-layer ceramic substrate and hence reduces the manufacturing costs, and also improves there liability of the multi-layer ceramic substrate.

The step of firing the plurality of glass-ceramic layers may include setting the firing temperature so that the plurality of glass-ceramic layers after fired have a density of 95% or more with respect to a density that the glass-ceramic layers exhibit when the degree of crystallinity is 25%. This provides the glass-ceramic layers with sufficient strength and sufficient density.

Preferably, a difference between the firing temperature in the step of firing the plurality of glass-ceramic layers and the firing temperature that produces the degree of crystallinity of 25% is −80° C. or above, and below −55° C.

Setting the firing temperature difference at −80° C. or above provides the glass-ceramic layers with sufficient strength and sufficient sintered density. Also, setting the firing temperature difference below −55° C. provides a degree of crystallinity not more than 12%, which prevents electric short circuits that would be caused by the migration.

Preferably, the amorphous glass includes silicic acid. This makes it easy to set the degree of crystallinity at 12% or less.

Preferably, the amorphous glass includes anorthite. This makes it still easier to set the degree of crystallinity at 12% or less.

The metal material may include silver. Setting the degree of crystallinity at 12% or less satisfactorily suppresses electric short circuits even when the interconnection pattern is formed of silver that tends to cause migration.

In the plurality of glass ceramic layers, the amorphous glass content “a” may be not less than 33 percent by weight nor more than 59 percent by weight and the alumina content “b” may be not less than 35 percent by weight nor more than 55 percent by weight, with a+b being not more than 100 percent by weight.

This makes it still easier to set the degree of crystallinity at 12% or less.

The step of firing the plurality of glass-ceramic layers may include setting the firing temperature in a range not less than 820° C. nor more than 860° C.

This provides the glass-ceramic layers with sufficient strength and sufficient sintered density and prevents electric short circuits that would be caused by the migration.

As above, the present invention provides a multi-layer ceramic substrate with high reliability and with improved yield and hence reduced manufacturing costs.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic perspective view of a multi-layer ceramic substrate according to an embodiment of the present invention;

FIG. 2 is a schematic perspective view illustrating a method for manufacturing the multi-layer ceramic substrate of FIG. 1;

FIG. 3 is a diagram showing an example of x-ray diffraction (XRD) measurements of the multi-layer ceramic substrate fired at 880° C.;

FIG. 4 is a diagram showing a relation among the firing temperature, sintered density, and degree of crystallinity in an example;

FIG. 5 is a diagram showing a relation between the firing temperature and firing shrinkage ratio in the example;

FIG. 6 is a diagram showing a relation between the firing temperature and mechanical characteristics exhibited after firing process in the example;

FIG. 7 is a diagram showing a relation between the firing temperature and the dielectric constant exhibited after firing process in the example;

FIG. 8 is a diagram showing a relation between the firing temperature and the incidence of short circuits in an example;

FIG. 9 is a schematic diagram showing a relation between the degree of crystallinity and the incidence of short circuits;

FIG. 10 is a diagram showing the details of the measurements of the degree of crystallinity and the incidence of short circuits;

FIG. 11 is a diagram showing a relation among a firing temperature difference, sintered density, and degree of crystallinity in the example;

FIG. 12 is a schematic cross-sectional view showing a part of the multi-layer ceramic substrate of FIG. 1;

FIG. 13 is a diagram showing a relation between measurements of regional silver contents and the incidence of short circuits;

FIGS. 14A and 14B are schematic perspective views illustrating a method of manufacturing a conventional multi-layer ceramic substrate; and

FIG. 15 is a diagram schematically illustrating a migration phenomenon.

### DESCRIPTION OF THE PREFERRED EMBODIMENTS

A multi-layer ceramic substrate and a manufacturing method according to an embodiment of the present invention will be described referring to the drawings.

FIG. 1 is a schematic perspective view illustrating the multi-layer ceramic substrate of the embodiment of the invention.

As shown in FIG. 1, the multi-layer ceramic substrate 10 is formed of a plurality of glass-ceramic layers 11A to 11D. The glass-ceramic layers 11A to 11D contain amorphous glass and alumina (Al₂O₃), where interconnection patterns 12A to 12D made of silver (partially not shown) are formed on surfaces of the glass-ceramic layers 11A to 11D. The details will be described later. The amorphous glass may be anorthite (CaAl₂Si₂O₈), for example.

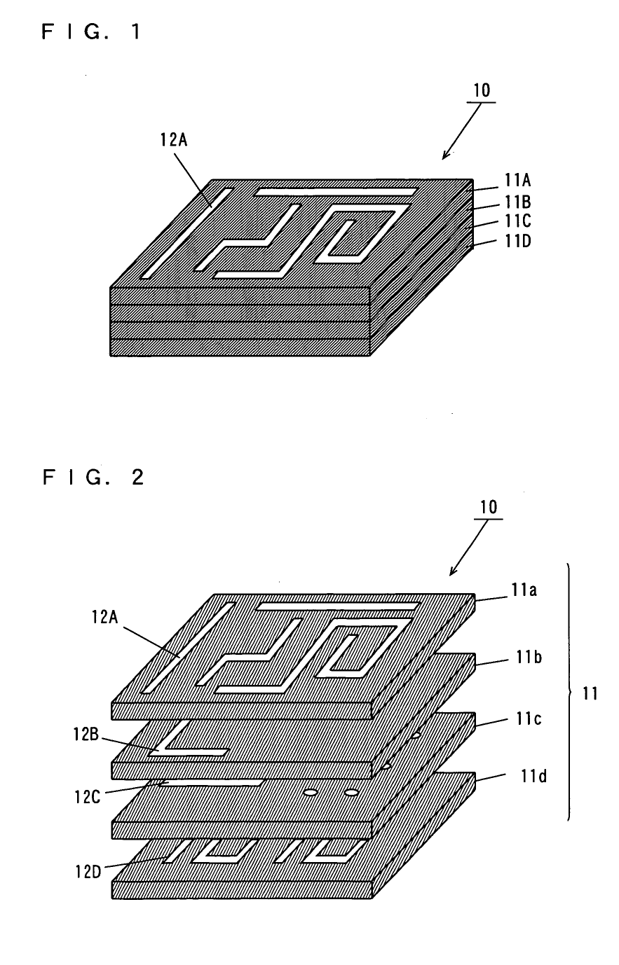

Next, a method for manufacturing the multi-layer ceramic substrate 10 of FIG. 1 is described. FIG. 2 is a schematic perspective view illustrating the method for manufacturing the multi-layer ceramic substrate 10 of FIG. 1.

As shown in FIG. 2, first, the interconnection patters 12A to 12D of silver are formed by screen-printing respectively on green sheets 11a to 11d mainly made of amorphous glass and alumina. The green sheets are made by mixing and kneading organic binder, ceramic material powder, etc., processing it into sheet form, and then drying it.

The green sheets 11a to 11d are stacked on top of each other and co-fired to form the multi-layer ceramic substrate 10 composed of the glass-ceramic layers 11A to 11D as shown in FIG. 1. The firing temperature for the formation of the multi-layer ceramic substrate 10 is from about 820° C. to about 860° C.

Table 1 shows an example of composition of the multi-layer ceramic substrate 10 of the embodiment.

TABLE 1

| | |
|---|---|
| Weight % | X-ray-diffraction intensity ratio |

| Amorphous | Alumina | (Degree of cystallinity) |
|---|---|---|
| glass | (Al₂ O₃) | I(glass)/I(Al₂ O₃) |
| 33˜59 | 55˜35 | ≦12% |

As shown in Table 1, the multi-layer ceramic substrate 10 of the embodiment contains 33 to 59 percent by weight of amorphous glass and 55 to 35 percent by weight of alumina (Al₂O₃). While the amorphous glass crystallizes as the green sheets are fired, the x-ray diffraction intensity ratio of Table 1 (hereinafter referred to as a degree of crystallinity) indicates the state of crystallization of the amorphous glass in comparison with that of alumina (polycrystal: Al₂O₃), which is represented by the expression below by using x-ray diffraction measurements:
Degree of crystallinity (%)=I(glass)/I(Al₂O₃)×100 (1)

Where I(glass) indicates an x-ray diffraction peak intensity of the amorphous glass (which mainly contains SiO₂) and I(Al₂O₃) indicates an x-ray diffraction peak intensity of the alumina.

With the multi-layer ceramic substrate 10 of the embodiment, the upper limit of the firing temperature is set so that the degree of crystallinity is equal to or below 12%.

On the other hand, on the basis of a density that the multi-layer ceramic substrate 10 exhibits after fired (hereinafter referred to as a sintered density) so that the degree of crystallinity is 25%, the lower limit of the firing temperature is set so that the sintered density is equal to or more than 95%.

According to the multi-layer ceramic substrate 10 of the embodiment, it is thought that, because the degree of crystallinity is 12% or less, the silver of the interconnection patterns 12A to 12D cannot move in the glass-ceramic layers 11A to 11D even when the silver is ionized. This prevents electric short circuits caused by the migration. This in turn enhances the yield of the multi-layer ceramic substrate 10 and thus reduces manufacturing costs, and also enhances the reliability of the multi-layer ceramic substrate 10.

Also, since the sintered density is 95% or more with respect to the sintered density that the multi-layer ceramic substrate 10 exhibits when the degree of crystallinity is 25%, the multi-layer ceramic substrate 10 offers sufficient strength and sufficient sintered density. Moreover, the interconnection patterns 12A to 12D made of silver offer high electric conductivity and allow the green sheets 11a to 11d to be fired in the atmosphere.

While four glass-ceramic layers 11A to 11D are stacked in the embodiment, the number of stacked layers is not limited to this number.

### EXAMPLES

In the examples below, the multi-layer ceramic substrate 10 was manufactured on the basis of the embodiment above and evaluations were made therewith.

### EXAMPLES

(Experiments on Firing Temperature)

In this example, a low-temperature co-fired ceramic (LTCC: GCS71 manufactured by NEC Glass Components, Ltd.) was used as the green sheets 11a to 11d. With the low-temperature co-fired ceramic, the manufacturer recommends firing temperatures of about 870° C. to about 900° C. for continuous furnaces for mass production.

Table 2 shows the compositions of the low-temperature co-fired ceramic used in the example. The low-temperature co-fired ceramic used in the example is formed of anorthite (CaAl₂Si₂O₈).

TABLE 2
Weight %

| SiO₂ | Al₂ O₃ | CaO | K₂ O |
|---|---|---|---|
| 33˜40 | 44˜52 | 8.0˜13.0 | 1.0˜3.0 |

As shown in Table 2, the low-temperature co-fired ceramic used in the example contains 33 to 40 percent by weight of silicon oxide (SiO₂), 44 to 52 percent by weight of alumina (Al₂O₃), 8.0 to 13.0 percent by weight of calcium oxide (CaO), and 1.0 to 3.0 percent by weight of potassium oxide (K₂O).

(Evaluations)

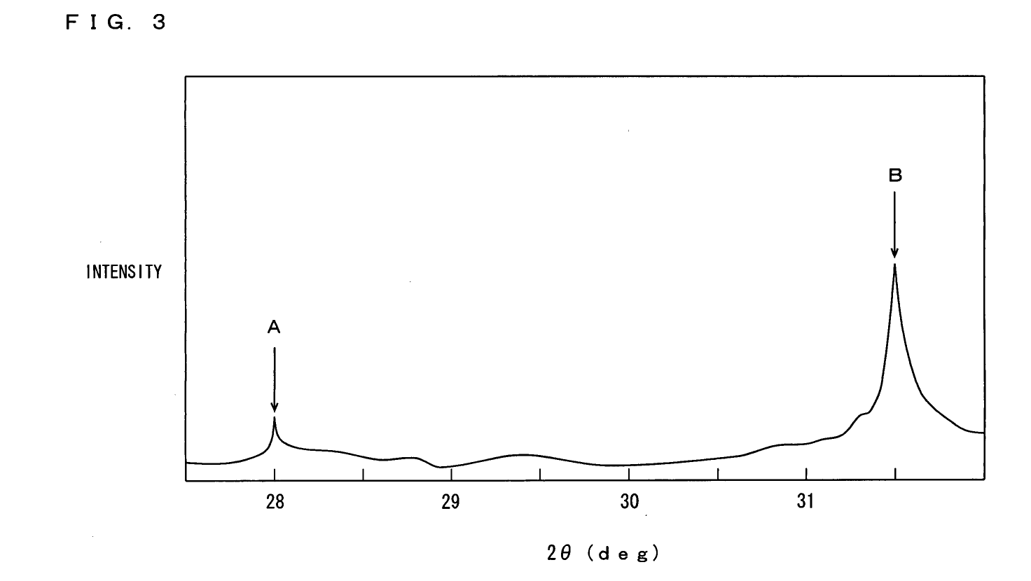

FIG. 3 is a diagram showing an example of an x-ray diffraction (XRD) spectrum of the multi-layer ceramic substrate 10. In FIG. 3, the vertical axis shows intensity and the horizontal axis shows angle of diffraction 2θ (deg).

As shown in FIG. 3, a peak A corresponding to anorthite (CaAl₂Si₂O₈) appears at the angle of diffraction 2θ=28.0 to 28.1 deg, and a peak B corresponding to alumina (Al₂O₃) appears at the angle of diffraction 2θ=31.0 to 31.2 deg.

As shown by expression (1) above, the degree of crystallinity is calculated from the intensity at the peak A and the intensity at the peak B.

(Investigations on Variations of Various Parameters with Varied Firing Temperatures)

Next, in this example, the low-temperature co-fired ceramic mentioned above was fired at varied temperatures of 800° C., 820° C., 840° C., 860° C., 880° C., and 900° C.

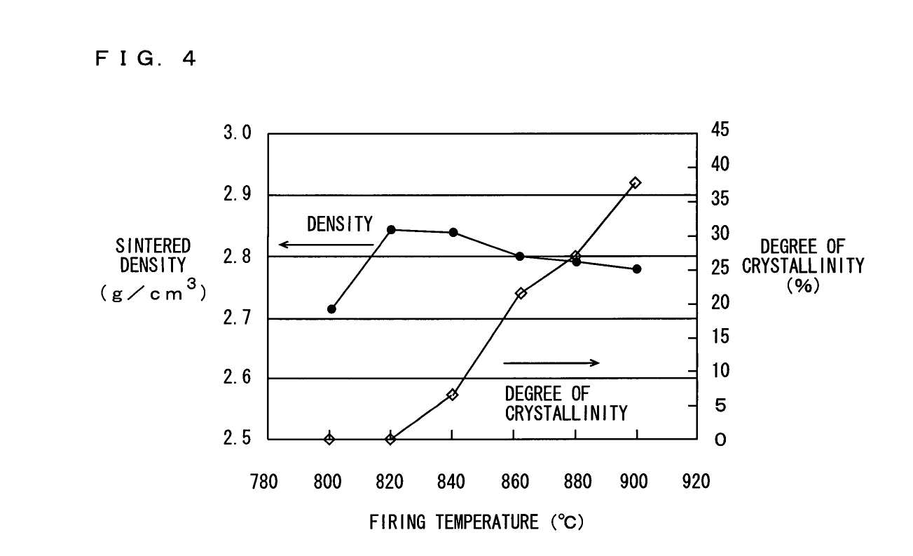

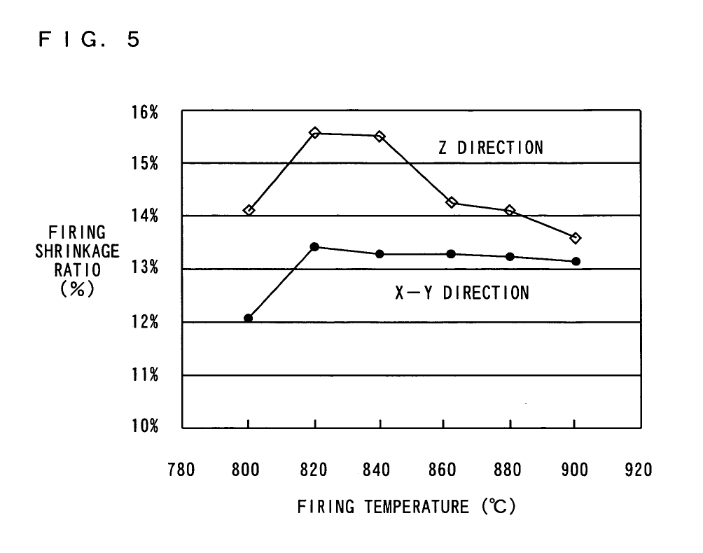

FIG. 4 is a diagram showing the relation among the firing temperature, sintered density, and degree of crystallinity in the example, and FIG. 5 is a diagram showing the relation between the firing temperature and firing shrinkage ratio in the example. In FIG. 4, the vertical axis on the left shows the sintered density, the vertical axis on the right shows the degree of crystallinity, and the horizontal axis shows the firing temperature. In FIG. 5, the vertical axis shows the firing shrinkage ratio and the horizontal axis shows the firing temperature.

In FIG. 5, the X-Y direction is the direction parallel to the surface of the green sheets and the Z direction is the direction vertical to the surface of the green sheets.

As shown in FIGS. 4 and 5, with the multi-layer ceramic substrate 10 of the example, the sintered density and the firing shrinkage ratios remain nearly constant at firing temperatures from about 820° C. to 900° C., and the sintered density and the firing shrinkage ratios decrease at firing temperatures below about 820° C. At the firing temperatures from about 820° C. to 900° C., the degree of crystallinity linearly increases as the firing temperature increases. At firing temperatures below about 820° C., the degree of crystallinity is 0%.

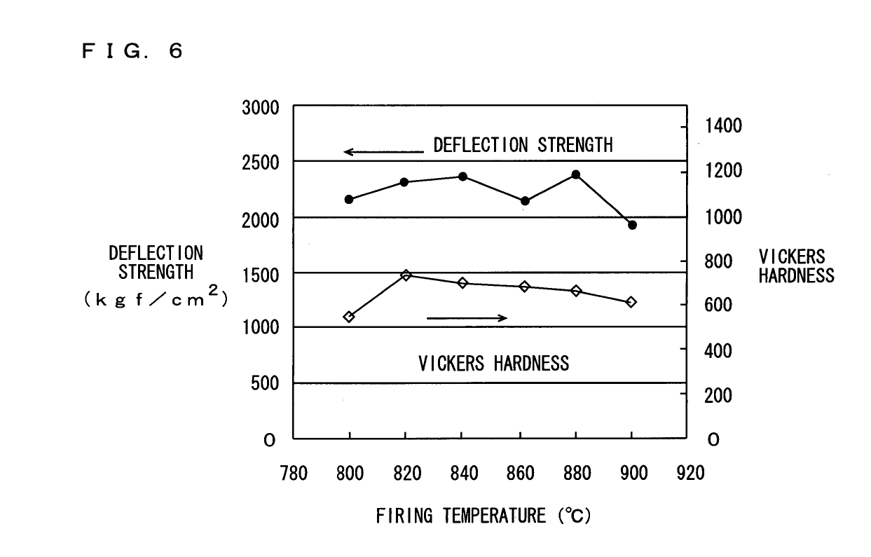

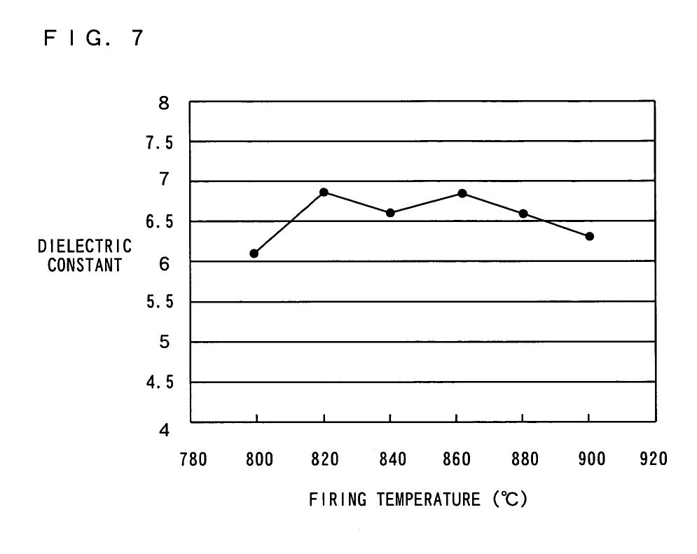

FIG. 6 is a diagram showing the relation between the firing temperature and mechanical characteristics obtained after firing process in the example, and FIG. 7 is a diagram showing the relation between the firing temperature and dielectric constant obtained after firing process in the example. In FIG. 6, the vertical axis on the left shows deflection strength, the vertical axis on the right shows Vickers hardness, and the horizontal axis shows the firing temperature. In FIG. 7, the vertical axis shows the dielectric constant and the horizontal axis shows the firing temperature.

As shown in FIGS. 6 and 7, with the multi-layer ceramic substrate 10 of the example, the deflection strength does not considerably vary at firing temperatures from about 800° C. to 900° C. Also, the Vickers hardness remains nearly constant at firing temperatures from about 820° C. to 900° C. However, the Vickers hardness decreases at firing temperatures below about 820° C. The dielectric constant, too, decreases at the firing temperatures below about 820° C.

These results show that the green sheets 11a to 11d are sufficiently fired when the firing temperature is about 820° C. or higher and the multi-layer ceramic substrate 10 offers sufficient mechanical and electric characteristics.

(Relation Between Firing Temperature and the Incidence of Short Circuits)

Next, in order to examine the relation between the firing temperature and the incidence of short circuits, 720 antenna switch modules were manufactured with multi-layer ceramic substrates (6.7 mm×5.0 mm) fired at varied temperatures in an experimental furnace.

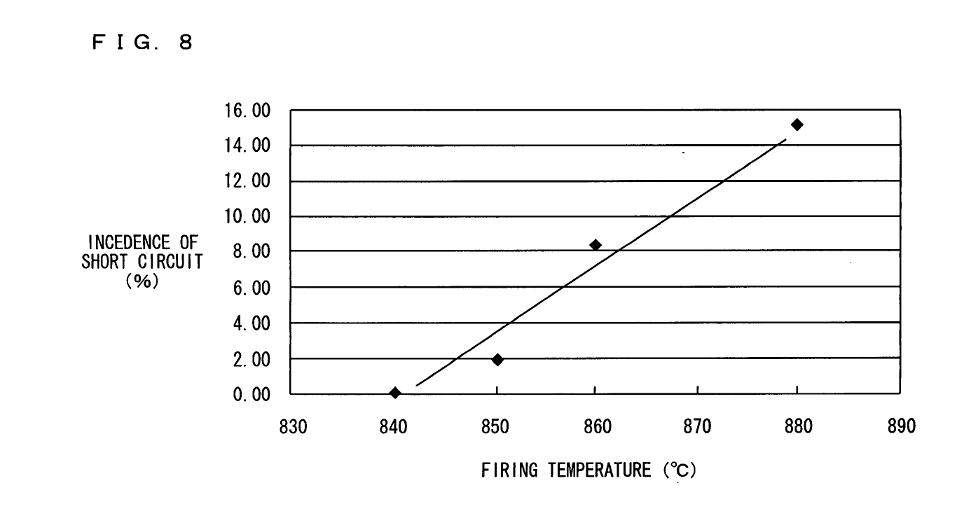

FIG. 8 is a diagram showing the relation between the firing temperature and the incidence of short circuits in the example. In FIG. 8, the vertical axis shows the incidence of short circuits and the horizontal axis shows the firing temperature.

As shown in FIG. 8, at firing temperatures of about 840° C. or below, the incidence of short circuits is nearly 0%, i.e., no defects. However, as the firing temperature is increased to 850° C., 860° C., and 880° C., the incidence of short circuits gradually increases to 2%, 8%, and 15%. This shows that increasing the firing temperature promotes the migration and increases the incidence of short circuits.

(Relation Between Degree of Crystallinity and the Incidence of Short Circuits)

Next, in order to examine the relation between the degree of crystallinity and the incidence of short circuits, the degrees of crystallinity of the antenna switch modules manufactured at varied firing temperatures were measured.

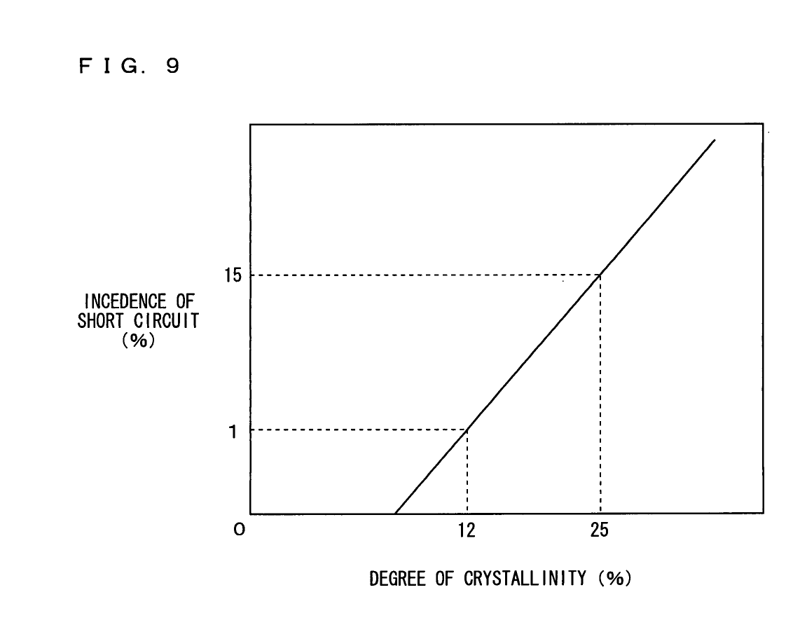

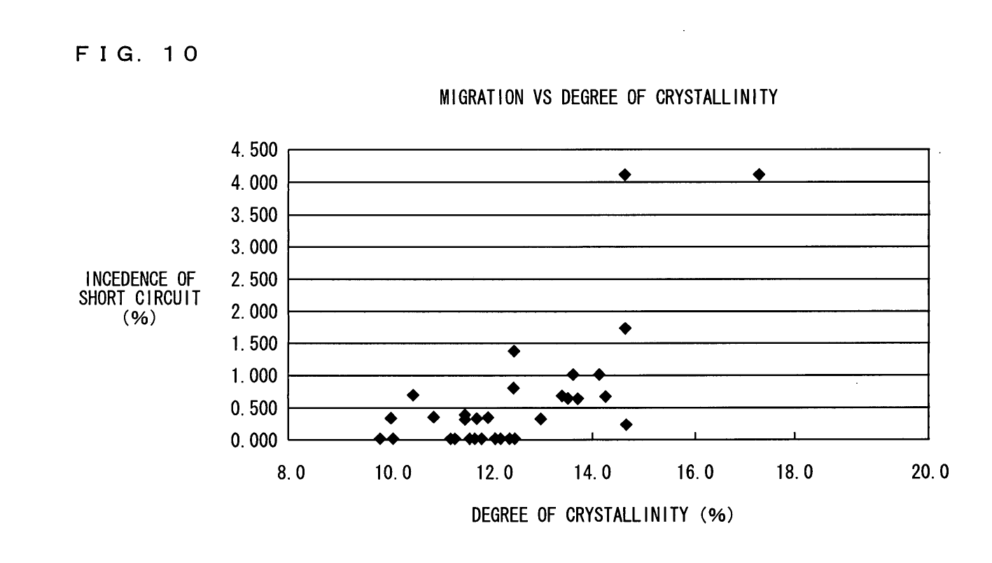

FIG. 9 is a schematic diagram showing the relation between the degree of crystallinity and the incidence of short circuits, and FIG. 10 is a diagram showing the details of the measurements of the degree of crystallinity and the incidence of short circuits. In FIGS. 9 and 10, the vertical axes show the incidence of short circuits and the horizontal axes show the degree of crystallinity.

The degree of crystallinity of 25% shown in FIG. 9 is the value obtained when the green sheets were fired at a recommended temperature of about 900° C. The incidence of short circuits in this case is 15%. The results of measurement shown in FIG. 10 indicate that the incidence of short circuits is suppressed to 1% or less when the degree of crystallinity is 12% or less.

(Relation Among Firing Temperature, Sintered Density, and Degree of Crystallinity)

Next, a relation among the firing temperature, the sintered density, and the degree of crystallinity was examined, where the sintered density indicates the sintered state of the multi-layer ceramic substrate.

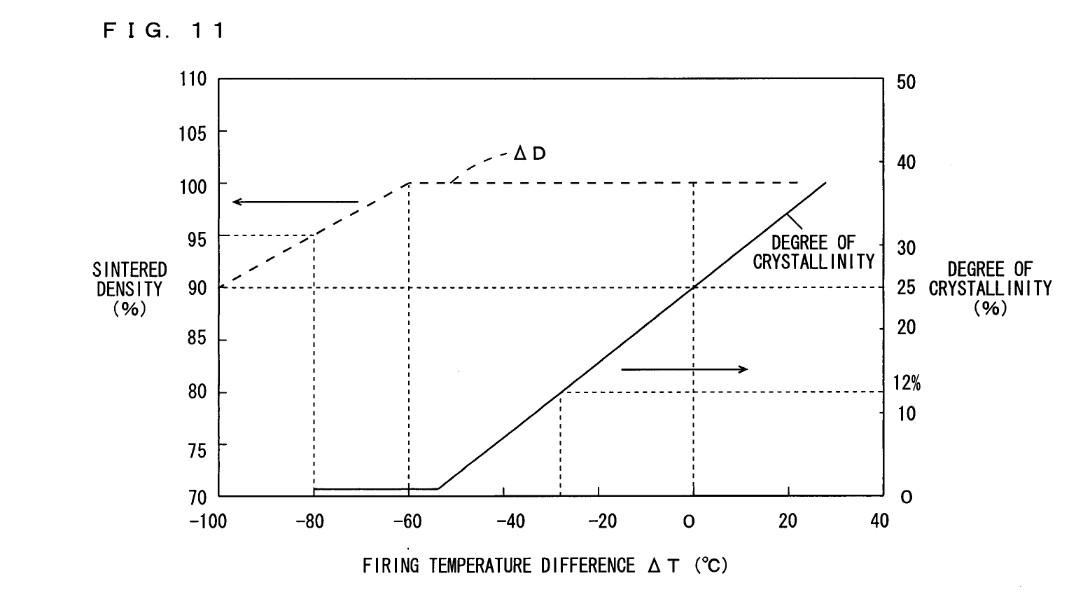

FIG. 11 is a diagram showing the relation among a firing temperature difference, the sintered density, and the degree of crystallinity in the example. In FIG. 11, the vertical axis on the left shows the sintered density, the vertical axis on the right shows the degree of crystallinity, and the horizontal axis shows the firing temperature difference.

As for the firing temperature difference ΔT of FIG. 11, the firing temperature at which the degree of crystallinity is 25% was defined as 0. The sintered density ΔD shows the ratio of density D2 at varied firing temperatures to the density D1 obtained when the firing temperature difference ΔT is 0 (when the degree of crystallinity is 25%), (D2/D1).

As shown in FIG. 11, when the firing temperature difference ΔT is between about −55° C. and +20° C., the degree of crystallinity linearly increases as the firing temperature increases. The degree of crystallinity is nearly 0% when the firing temperature difference ΔT is below about −55° C.

When the firing temperature difference ΔT is between about −60° C. and +20° C., the sintered density ΔD remains constant. It is also seen that the sintered density ΔD tends to decrease as the firing temperature difference ΔT varies below about −60° C.

Also, FIG. 11 shows that, even when the degree of crystallinity is 0%, the sintered density ΔD remains nearly constant in a certain temperature range, meaning that the multi-layer ceramic substrate 10 was sufficiently sintered. Also, in the formation of the multi-layer ceramic substrate 10, when sintered densities that are allowable in terms of mechanical and electrical characteristics are 95% or higher with respect to the sintered density obtained when the degree of crystallinity is 25%, then it is seen that firing temperature differences ΔT down to −80° C. are possible.

From these results, in the formation of the multi-layer ceramic substrate 10, it is preferable to set the lower limit of the firing temperature so that the firing temperature difference ΔT is −80° C. or above. In this case, the glass-ceramic layers are provided with sufficient strength and sufficient sintered density.

(About Relation Between Silver Content and the Incidence of Short Circuits)

Next, the relation between the content of silver and the incidence of short circuits was examined with a multi-layer ceramic substrate 10 having a degree of crystallinity not more than 12%.

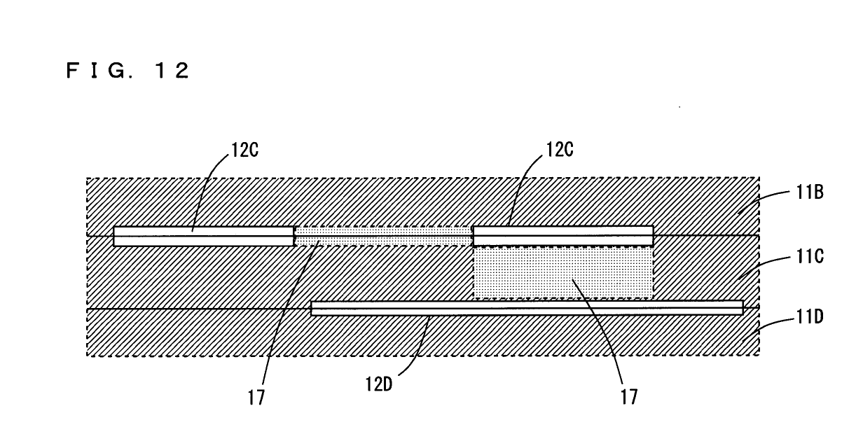

FIG. 12 is a schematic cross-sectional view showing a part of the multi-layer ceramic substrate 10 of FIG. 1.

As shown in FIG. 12, the interconnection pattern 12C is printed on the glass-ceramic layer 11C and the interconnection pattern 12D is printed on the glass-ceramic layer 11D.

The region between the two portions of the interconnection pattern 12C and the region between the interconnection patterns 12C and 12D are referred to as regions 17. The silver contents in these regions 17 were measured with an x-ray microanalyzer (EPMA). Table 3 shows the result of silver content measurement with x-ray microanalyzer (EPMA).

TABLE 3
Weight % (Regions 17)

| Amorphous | Alumina | |
|---|---|---|
| glass | (Al₂ O₃) | Silver |
| 33˜59 | 55˜35 | ≦4 |

As shown in Table 3, the regions 17 contain 33 to 59 percent by weight of amorphous glass and 55 to 35 percent by weight of alumina (Al₂O₃).

Also, the x-ray microanalyzer measurements showed that the silver contents in the regions 17 were 4% or less.

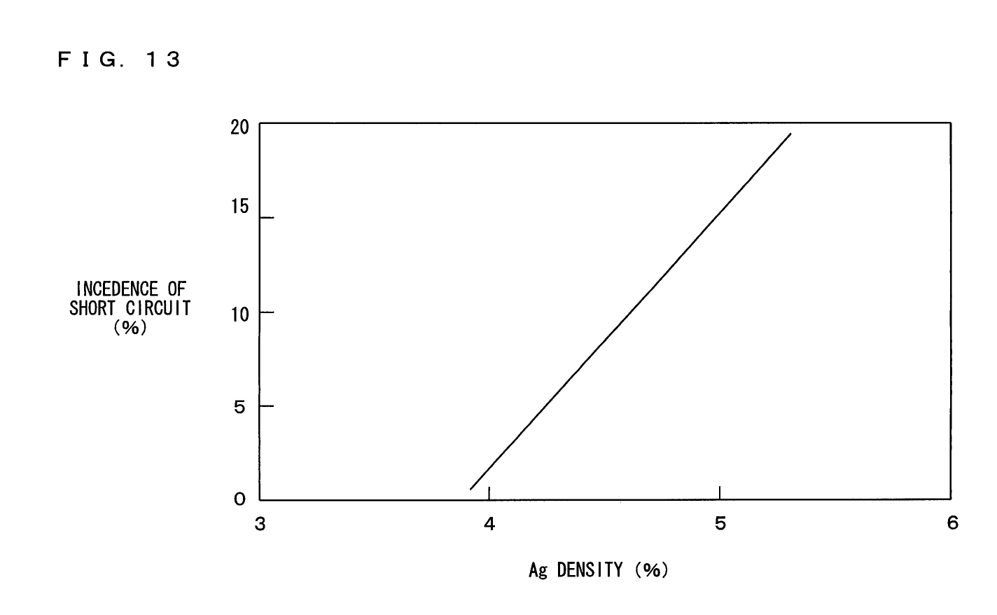

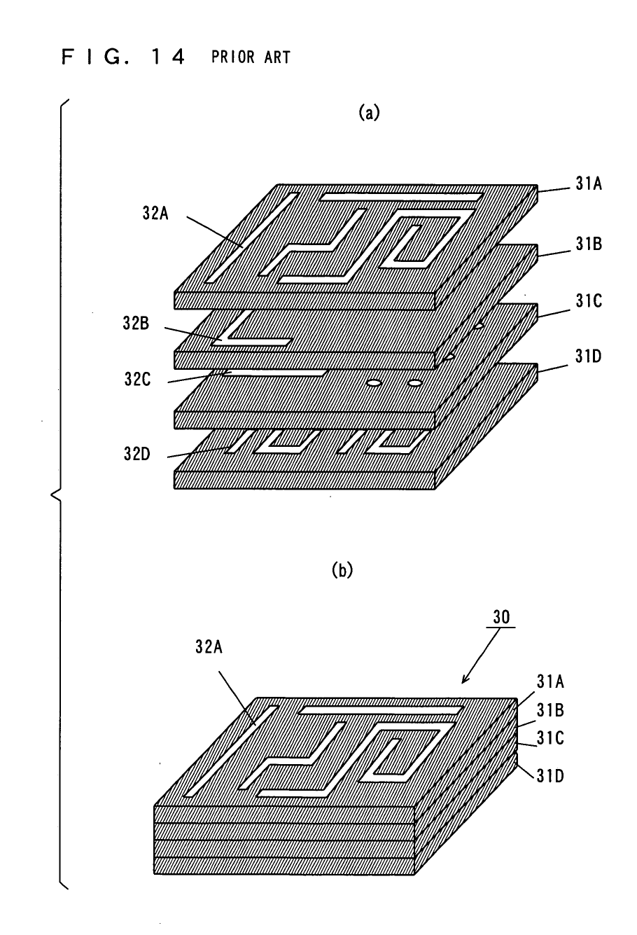

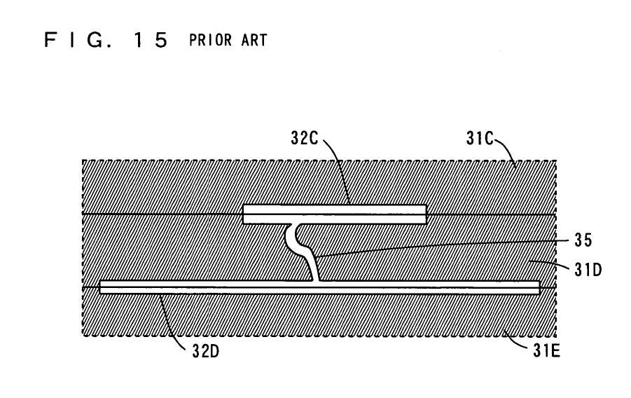

FIG. 13 is a diagram showing the relation between the silver content measurements in the regions 17 and the incidence of short circuits. In FIG. 13, the vertical axis shows the incidence of short circuits and the horizontal axis shows the silver (Ag) content.

According to FIG. 13, in the regions 17 of the glass-ceramic layers 11A to 11D that are interposed between opposing portions of the interconnection patterns 12A to 12D, the incidence of short circuits is approximately 1% or less when the silver content is 4% or less.

As described so far, it is seen that the electric short circuits of the multi-layer ceramic substrate 10 can be sufficiently prevented by setting the firing temperature so that the degree of crystallinity is 12% or less.

It seems that this is because silver, even when ionized, cannot move in the glass-ceramic layers 11A to 11D when the degree of crystallinity is 12% or less.

It was also found that electric short circuits can be sufficiently prevented when the silver content is 4% or less in regions interposed between opposing portions of the silver interconnection patterns 12A to 12D.

While the invention has been described in detail, the foregoing description is in all aspects illustrative and not restrictive. It is understood that numerous other modifications and variations can be devised without departing from the scope of the invention.

1. A multi-layer ceramic substrate, comprising:
a plurality of stacked glass-ceramic layers; and
an interconnection pattern made of a metal material and formed in at least one surface of said plurality of glass-ceramic layers,
said plurality of glass-ceramic layers comprising amorphous glass and alumina,
with a degree of crystallinity, which is represented as a ratio of an x-ray diffraction peak intensity of said amorphous glass to an x-ray diffraction peak intensity of said alumina, being 12% or less.

2. The multi-layer ceramic substrate according to claim 1, wherein said plurality of glass-ceramic layers have a density of 95% or more with respect to a density that the glass-ceramic layers exhibit when said degree of crystallinity is 25%.

3. The multi-layer ceramic substrate according to claim 1, wherein said amorphous glass comprises silicic acid.

4. The multi-layer ceramic substrate according to claim 1, wherein said amorphous glass comprises anorthite.

5. The multi-layer ceramic substrate according to claim 1, wherein said metal material comprises silver.

6. The multi-layer ceramic substrate according to claim 1, wherein said interconnection pattern has portions that are located opposite to each other and a region of the glass-ceramic layers that is interposed between said opposite portions has a silver content of 4% or less.

7. The multi-layer ceramic substrate according to claim 1, wherein said plurality of glass ceramic layers have anamorphous glass content “a” of not less than 33 percent by weight nor more than 59 percent by weight and an alumina content “b” of not less than 35 percent by weight nor more than 55 percent by weight, with a+b being not more than 100 percent by weight.

8. A method for manufacturing a multi-layer ceramic substrate, comprising the steps of:
forming a plurality of glass-ceramic layers that contain amorphous glass and alumina;
providing an interconnection pattern of a metal material in at least one surface of said plurality of glass-ceramic layers; and
stacking said plurality of glass-ceramic layers and firing said plurality of glass-ceramic layers at such a firing temperature that a degree of crystallinity, which is represented as a ratio of an x-ray diffraction peak intensity of said amorphous glass to an x-ray diffraction peak intensity of said alumina, is 12% or less.

9. The multi-layer ceramic substrate manufacturing method according to claim 8, wherein said step of firing said plurality of glass-ceramic layers comprises setting the firing temperature so that said plurality of glass-ceramic layers after fired have a density of 95% or more with respect to a density that said glass-ceramic layers exhibit when said degree of crystallinity is 25%.

10. The multi-layer ceramic substrate manufacturing method according to claim 8, wherein a difference between the firing temperature in said step of firing said plurality of glass-ceramic layers and a firing temperature that produces the degree of crystallinity of 25% is −80° C. or above, and below −55° C.

11. The multi-layer ceramic substrate manufacturing method according to claim 8, wherein said amorphous glass comprises silicic acid.

12. The multi-layer ceramic substrate manufacturing method according to claim 8, wherein said amorphous glass comprises anorthite.

13. The multi-layer ceramic substrate manufacturing method according to claim 8, wherein said metal material comprises silver.

14. The multi-layer ceramic substrate manufacturing method according to claim 8, wherein said plurality of glass ceramic layers have an amorphous glass content “a” of not less than 33 percent by weight nor more than 59 percent by weight and an alumina content “b” of not less than 35 percent by weight nor more than 55 percent by weight, with a+b being not more than 100 percent by weight.

15. The multi-layer ceramic substrate manufacturing method according to claim 8, wherein said step of firing said plurality of glass-ceramic layers comprises setting the firing temperature in a range not less than 820° C. nor more than 860° C.
